(19) United States
(12) Patent Application Publication
(10) Pub. No.: US 2017/0139516 A1
(43) Pub. Date: May 18, 2017

(54) LAMINATE STRUCTURE AND TOUCH PANEL MODULE

(71) Applicant: FUJIFILM Corporation, Tokyo (JP)

(72) Inventors: Takashi KOIKE, Kanagawa (JP); Hisashi TSUBATA, Kanagawa (JP); Takayoshi KUWABARA, Kanagawa (JP); Minoru ARAKI, Kanagawa (JP)

(73) Assignee: FUJIFILM Corporation, Tokyo (JP)

(21) Appl. No.: 15/417,394

(22) Filed: Jan. 27, 2017

Related U.S. Application Data
(63) Continuation of application No. PCT/JP2015/069660, filed on Jul. 8, 2015.

(30) Foreign Application Priority Data
Aug. 28, 2014 (JP) 2014-173921

(51) Int. Cl. G06F 3/041; B32B 7/12; B32B 5/02; G06F 3/044

(52) U.S. Cl. CPC G06F 3/0412; G06F 3/044; B32B 7/12; B32B 5/028; G06F 2203/04102; G06F 2203/04112; B32B 2457/208

(57) ABSTRACT

A laminate structure includes a laminate which has a three-dimensional shape and is provided with a transparent conductive member having a plurality of conductive layers constituted of fine metal wires on a flexible transparent substrate, a wiring formed on the transparent substrate and electrically connected to each conductive layer, a protective member having an optically transparent region and protecting the transparent conductive member, and an optically transparent adhesive layer positioned between the transparent conductive member and the protective member. The laminate has at least a planar portion and a bent portion formed continuously to the planar portion. The wiring is routed to the bent portion and is connected to a flexible wiring member at the tip of the bent portion.

### CROSS-REFERENCE TO RELATED APPLICATIONS

This application is a Continuation of PCT International Application No. PCT/JP2015/069660 filed on Jul. 8, 2015, which claims priority under 35 U.S.C. §119(a) to Japanese Patent Application No. 2014-173921 filed on Aug. 28, 2014. The above application is hereby expressly incorporated by reference, in its entirety, into the present application.

### BACKGROUND OF THE INVENTION

1. Field of the Invention

The present invention relates to a laminate structure having a three-dimensional shape and a touch panel module having a laminate structure, and in particular, to a laminate structure and a touch panel module less susceptible to noise.

2. Description of the Related Art

In recent years, a touch panel is increasingly employed as an input device of a portable electronic apparatus, such as a smartphone or a tablet personal computer (PC). In these apparatuses, high portability, operability, and designability are required. For example, a device having a curved shape can be used in a state of being mounted on a part of a body. Furthermore, for example, an input part is provided not only on a display screen but also on a side surface or in a ridge portion, whereby it is possible to improve operability even in a small apparatus.

If a touch sensor function is applied to an exterior cover of a portable apparatus, it is possible to achieve reduction in the number of parts and to realize reduction in size of a device and improvement of portability. In addition, if the shape of the touch panel is stereoscopically designed freely, it is possible to design a device freely and to manufacture a device having high designability.

However, since a touch panel of the related art has a planar shape and has a limited input surface, in order to realize the above-described function, it is necessary to combine a plurality of input apparatuses, and as a result, since the shape or size of the apparatus is limited, it is difficult to carry out such operation.

In order to realize the above-described function, a technique which three-dimensionally processes a touch panel has been attracting attention. As such a technique, for example, a technique which three-dimensionally deforms the shape of a touch sensor film formed by applying a conductive layer to a flexible polymer film base material using a mold or the like, and then, integrates the touch sensor film with a resin base material, such as a polycarbonate, is known.

For example, WO2012/132846A describes a touch screen in which a film sensor is attached to the rear surface side of a cover lens having a three-dimensional shape. Specifically, the cover lens is a casing structure having a rectangular top plate, a striped first side plate continued to one side of the top plate, and a striped second side plate continued to another side of the top plate facing the first side plate.

### SUMMARY OF THE INVENTION

In a touch sensor film made of a thin film of metal oxide, such as indium tin oxide (ITO) transparent conductive film of the related art, since a crack or disconnection occurs due to processing, it is not suitable for processing. If a conductive film having a mesh structure of fine metal wires is provided, even if deformation, such as folding or extension, is performed, since disconnection hardly occur, it is possible to realize a three-dimensional shape.

Realization of a cover member shape with a planar portion to be a main touch input surface and a side portion of a module integrated using the above-described processing method has been studied. If such a structure can be realized, for example, a peripheral wiring region of a touch sensor is arranged in a module side portion, whereby it is possible to reduce a peripheral frame region of a front image display portion serving as a touch input surface and to manufacture a touch panel module having high designability.

The touch sensor film with the cover member and an electric circuit board comprising a controller for driving the touch panel module are normally connected by a flexible circuit board (hereinafter, referred to as FPC). If the touch input surface is touched with a finger, change in electric characteristic occurs in the touch sensor film, and a signal indicating the change is transmitted to the controller (electric circuit board) through a peripheral wiring portion and is reflected as information of the image display portion. A wiring portion between the touch panel and the controller (electric circuit board) is susceptible to electric noise from the outside, and if the influence of noise is large, a normal operation as the touch panel may not be performed. For this reason, a measure to cut noise by providing a shield electrode or a wiring pattern having a corresponding function in the touch sensor film, the FPC, or the like is taken; however, there is a problem in which design of the pattern of the touch sensor film, the FPC, or the like becomes complicated.

In the related art, since the electric circuit board comprising the controller for driving the touch panel is arranged on the rear surface of a display device, in a touch panel module having a planar shape of the related art, a flexible circuit board (FPC) connecting a sensor film and an electric circuit wraps around the display device. For this reason, it is necessary to secure a long wiring distance of the FPC, and the FPC is susceptible to electric noise from the outside. For this reason, there is a need to develop a touch panel module which is unsusceptible to electric noise from the outside.

In a case where a touch panel is formed in a three-dimensional shape, and an input portion is applied to a ridge portion in a touch sensor film, in the ridge portion, since an electrode conductive layer is bent, sensing is difficult, and in order to allow sensing in the ridge portion, it is necessary to minimize other kinds of noise. In order to minimize noise, it is necessary to shorten a lead wire connected to the bent electrode conductive layer.

An object of the invention is to eliminate the problems in the related art described above, and to provide a laminate structure unsusceptible to noise and a touch panel module having a laminate structure.

In order to attain the above-described object, the invention provides a laminate structure comprising a laminate which has a three-dimensional shape and is provided with a protective member, at least one conductive layer formed on the protective member, and a wiring electrically connected to the conductive layer. The laminate is provided with at least a planar portion and a bent portion formed continuously to the planar portion, and the wiring is routed to the bent portion and connected to a flexible wiring member at the tip of the bent portion.

The invention provides a laminate structure comprising a laminate which has a three-dimensional shape and is provided with a transparent conductive member having a plurality of conductive layers constituted of fine metal wires on a flexible transparent substrate, a wiring formed on the transparent substrate and electrically connected to each conductive layer, a protective member having an optically transparent region and protecting the transparent conductive member, and an optically transparent adhesive layer positioned between the transparent conductive member and the protective member. The laminate comprises at least a planar portion and a bent portion formed continuously to the planar portion, and the wiring is routed to the bent portion and connected to a flexible wiring member at the tip of the bent portion.

It is preferable that the total length of the wiring electrically connected to a conductive layer arranged across the bent portion among the plurality of conductive layers is shorter than the total length of the wiring electrically connected to other conductive layers. Furthermore, for example, the wiring member is connected to an external apparatus.

It is preferable that the transparent conductive member is arranged inside the bent portion of the protective member.

For example, the conductive layers have a conductive pattern having a mesh structure constituted of the fine metal wires.

It is preferable that the conductive layers are formed on both surfaces of the transparent substrate.

The conductive layers may be formed on one surface of the transparent substrate, and two transparent substrates on which the conductive layers are formed on one surface are laminated.

It is preferable that the wiring routed to the bent portion is connected to a terminal provided at the tip of the bent portion, and the wiring member is connected to the terminal.

It is preferable that the wiring routed to the bent portion is connected separately to a plurality of terminals provided at the tip of the bent portion, and the wiring member is connected to the plurality of terminals. In this case, it is preferable that the wiring member connected to the plurality of terminals is one wiring member having branch portions corresponding to the number of the plurality of terminals. Furthermore, it is preferable that the transparent conductive member protrudes from the protective member.

There is also provided a touch panel module comprising: a laminate structure including a laminate which has a three-dimensional shape and is provided with a protective member, at least one conductive layer formed on the protective member, and a wiring electrically connected to the conductive layer, wherein the laminate has at least a planar portion and a bent portion formed continuously to the planar portion, and the wiring is routed to the bent portion and is connected to a flexible wiring member at the tip of the bent portion.

According to the invention, it is possible to obtain a laminate structure unsusceptible to noise and a touch panel module having a laminate structure.

### BRIEF DESCRIPTION OF THE DRAWINGS

FIG. 1 is a schematic perspective view showing a touch panel having a laminate structure according to an embodiment of the invention.

FIG. 2 is a schematic sectional view of a main part of the touch panel according to the embodiment of the invention.

FIG. 3A is a schematic view showing a laminate of a laminate structure according to the embodiment of the invention, FIG. 3B is a schematic sectional view showing an example of a transparent conductive member, and FIG. 3C is a schematic view showing a modification example of an example of the laminate of the laminate structure according to the embodiment of the invention.

FIG. 4A is a schematic view showing another example of the laminate of the laminate structure according to the embodiment of the invention, FIG. 4B is a schematic sectional view showing another example of a transparent conductive member, and FIG. 4C is a schematic view showing a modification example of another example of the laminate of the laminate structure according to the embodiment of the invention.

FIG. 5 is a schematic view showing an example of the arrangement of first conductive layers and first wirings in the laminate of the laminate structure according to the embodiment of the invention.

FIG. 6 is a schematic view showing another example of the arrangement of the first conductive layers and the first wirings in the laminate of the laminate structure according to the embodiment of the invention.

FIG. 7 is a schematic view showing another example of the arrangement of the first conductive layers and the first wirings in the laminate of the laminate structure according to the embodiment of the invention.

FIG. 8 is a schematic view showing an example of the arrangement of second conductive layers and second wirings in the laminate of the laminate structure according to the embodiment of the invention.

FIG. 9 is a schematic view showing another example of the arrangement of the second conductive layers and the second wirings in the laminate of the laminate structure according to the embodiment of the invention.

FIG. 10 is a schematic view showing an example of a first conductive pattern of the first conductive layers in the laminate of the laminate structure according to the embodiment of the invention.

FIG. 11 is a schematic view showing an example of a second conductive pattern of the second conductive layers in the laminate of the laminate structure according to the embodiment of the invention.

FIG. 12 is a schematic view showing a combination pattern obtained by arranging the first conductive pattern and the second conductive pattern to face each other in the laminate of the laminate structure according to the embodiment of the invention.

FIGS. 13A to 13C are schematic views showing a method of molding the laminate structure according to the embodiment of the invention.

### DESCRIPTION OF THE PREFERRED EMBODIMENTS

Hereinafter, a laminate structure and a touch panel module of the invention will be described in detail based on a preferred embodiment shown in the accompanying drawings. It should be noted that the invention is not limited to the following embodiment.

In the following description, “to” indicating a numerical value range includes numerical values described on both sides. For example, when ε is a numerical value α to a numerical value β, the range of ε is a range including the numerical value α and the numerical value β, and is represented as α≦ε≦β using mathematical symbols.

The term “transparent” means that light transmittance is at least equal to or greater than 60% at a visible light wavelength (wavelength 400 nm to 800 nm), preferably, equal to or greater than 80%, more preferably, equal to or greater than 90%, and still more preferably, equal to or greater than 95%.

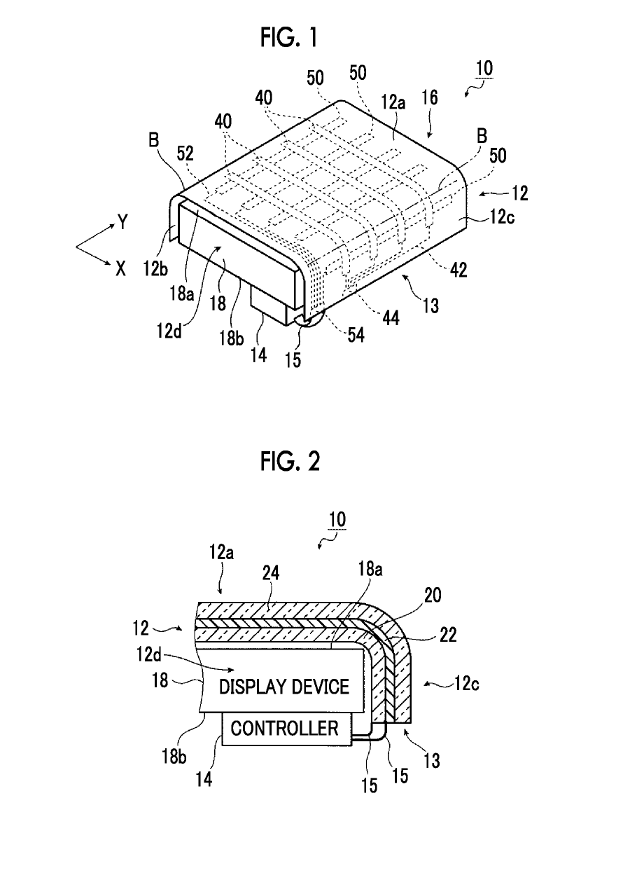

FIG. 1 is a schematic perspective view showing a touch panel having a laminate structure according to an embodiment of the invention. FIG. 2 is a schematic sectional view of a main part of the touch panel according to the embodiment of the invention.

The laminate structure of the invention can be used in, for example, a touch panel. As a specific example, for example, a touch panel 10 using a laminate structure 12 shown in FIG. 1 will be described.

The touch panel 10 is used along with a display device 18, such as a liquid crystal display (LCD), and is provided on the display device 18. For this reason, in order to allow an image displayed on the display device 18 to be recognized, an optically transparent region is provided. The display device 18 is not particularly limited as long as an image including a motion image or the like can be displayed on a screen, and for example, a liquid crystal display, an organic EL device, an electronic paper, or the like can be used.

The touch panel 10 shown in FIG. 1 has a laminate structure 12 and a controller 14, and the laminate structure 12 and the controller 14 are connected by a flexible wiring member, for example, a flexible circuit board 15 (hereinafter, referred to as FPC 15).

If the touch panel 10 is touched with a finger or the like, change in capacitance occurs at the touched position, the change in capacitance is detected by the controller 14, and the coordinates of the touched position are specified. The controller 14 is an external apparatus of the laminate structure 12, and is constituted of a known controller which is used for detection on the touch panel. If the touch panel is a capacitance type, a capacitance type controller can be suitably used, and if the touch panel is a resistive film type, a resistive film type controller can be suitably used.

The laminate structure 12 has a laminate 20 and the FPC 15, and has a three-dimensional shape. The laminate structure 12 comprises at least a planar portion 12a, and two bent portions 12b and 12c formed continuously to the planar portion 12a. The two bent portions 12b and 12c are formed by bending both end portions of the planar portion 12a. Portions where the planar portion 12a is bent are referred to as bending portions B.

The display device 18, such as an LCD, is arranged in a recess portion 12d constituted by the planar portion 12a and the bent portions 12b and 12c of the laminate structure 12 such that a display surface 18a turns toward the planar portion 12a. The controller 14 is provided on a rear surface 18b of the display device 18.

Since the display device 18 is arranged, the laminate structure 12 makes the planar portion 12a and the bent portions 12b and 12c transparent suitably according to the range of the display surface 18a such that an image including a motion image or the like displayed on the display surface 18a can be recognized.

The laminate structure 12 has the laminate 20 having a three-dimensional shape corresponding to the planar portion 12a and the bent portions 12b and 12c. In the laminate structure 12, a cover member 24 is provided, and as shown in FIG. 2, the laminate 20 is attached to the rear surface of the cover member 24 having a three-dimensional shape similar to the laminate 20, for example, by an optically transparent adhesive layer 22.

The adhesive layer 22 is not particularly limited as long as the adhesive layer is optically transparent and can bond the laminate 20 to the cover member 24. For example, an optically transparent adhesive (OCA), or optically transparent resin (OCR), such as UV curable resin, can be used.

The cover member 24 is to protect the laminate 20, and for example, is made of, for example, polycarbonate, glass, or the like. Preferably, the cover member 24 is also transparent such that a display image of the display device 18 can be recognized.

An X direction and a Y direction shown in FIG. 1 are orthogonal to each other. As shown in FIG. 1, in the laminate structure 12, a plurality of first conductive layers 40 extending in the X direction are arranged at intervals in the Y direction. The first conductive layers 40 are arranged in the planar portion 12a and the bent portions 12b and 12c, and extend over the bent portions 12b and 12c. A plurality of second conductive layers 50 extending in the Y direction are arranged at intervals in the X direction. The second conductive layers 50 are provided in the planar portion 12a, the bent portion 12b, and the bent portion 12c.

The respective first conductive layers 40 are electrically connected to terminal portions (not shown) at one end thereof. In addition, the respective terminal portions are electrically connected to first wirings 42. The respective first wirings 42 are routed to a tip 13 of one bent portion 12c out of the two bent portions 12b and 12c, and are integrated and connected to a terminal 44 provided at the tip 13. The FPC 15 provided at the tip 13 is connected to the terminal 44, and the FPC 15 is connected to the controller 14.

The respective second conductive layers 50 are electrically connected to terminal portions (not shown) at one end thereof. The respective terminal portions are electrically connected conductive second wirings 52. The respective second wirings 52 are routed to the tip 13 of one bent portion 12c, and are integrated and connected to a terminal 54 provided at the tip 13. The FPC 15 provided at the tip 13 is connected to the terminal 54, and the FPC 15 is connected to the controller 14.

The first conductive layers 40, the first wirings 42, and the terminal 44, and the second conductive layers 50, the second wirings 52, and the terminal 54 will be described below in detail.

The laminate structure 12 and the controller 14 constitute a touch panel module 16.

Since the first conductive layers 40 extending over the bent portions 12b and 12c are hardly detected correctly, and adjustment for detection becomes complicated, the first wirings 42 are arranged as short as possible, whereby it is possible to obtain the laminate structure 12 unsusceptible to noise and the touch panel module 16 having the laminate structure 12.

Next, the laminate 20 constituting the laminate structure 12 will be described.

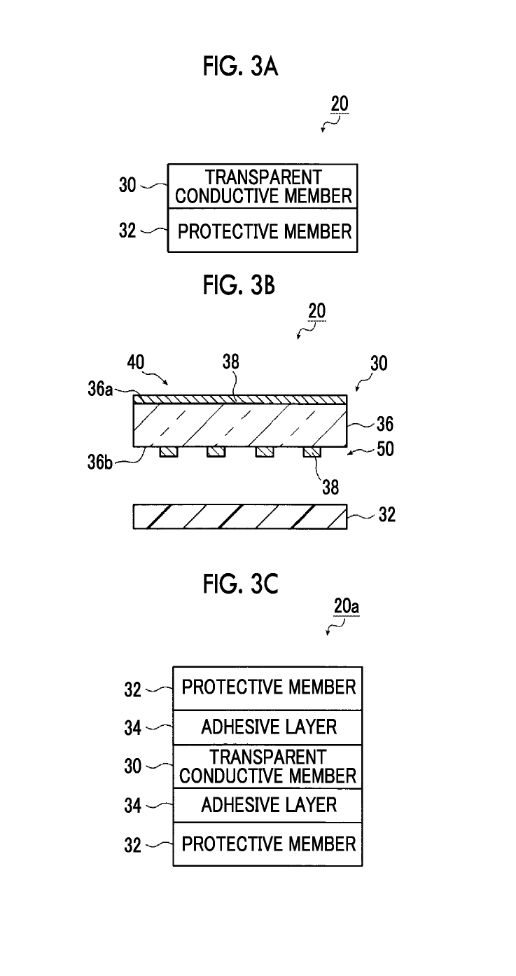

FIG. 3A is a schematic view showing the laminate of the laminate structure according to the embodiment of the invention, and FIG. 3B is a schematic sectional view showing an example of a transparent conductive member. The laminate 20 has a three-dimensional shape like the laminate structure 12, and in FIGS. 3A and 3B, in order to show the configuration of the laminate 20, the laminate 20 is shown in a planar shape.

The laminate 20 is constituted by laminating a protective member 32 and a transparent conductive member 30 in this order from below.

The transparent conductive member 30 corresponds to a touch sensor portion of the touch panel 10. The transparent conductive member 30 has a plurality of conductive layers constituted of conductive fine metal wires 38 (see FIG. 3B) on both surfaces of a flexible transparent substrate 36 (see FIG. 3B).

In the transparent conductive member 30, as shown in FIG. 3B, the first conductive layers 40 constituted of the fine metal wires 38 are formed on a front surface 36a of the transparent substrate 36, and the second conductive layers 50 constituted of the fine metal wires 38 are formed on a rear surface 36b of the transparent substrate 36. In the transparent conductive member 30, the first conductive layers 40 and the second conductive layers 50 are arranged to face each other and to be orthogonal to each other in a plan view. The first conductive layers 40 and the second conductive layers 50 are to detect a touch. The conductive patterns of the first conductive layers 40 and the second conductive layers 50 are not particularly limited, and may be bar-shaped, and an example of the conductive pattern is described below.

The first conductive layers 40 and the second conductive layers 50 are respectively formed on the front surface 36a and the rear surface 36b of one transparent substrate 36, whereby it is possible to reduce deviation in the positional relationship between the first conductive layers 40 and the second conductive layers 50 even if the transparent substrate 36 shrinks.

Though not shown, the first wirings 42 which are connected to the first conductive layers 40 and the terminal 44 to which the first wirings 42 are connected are formed on the front surface 36a of the transparent substrate 36.

Though not shown, the second wirings 52 which are connected to the second conductive layers 50 and the terminal 54 to which the second wirings 52 are connected are formed on the rear surface 36b of the transparent substrate 36.

The protective member 32 is to protect the transparent conductive member 30, and in particular, any conductive layer, and for example, is provided to be brought into contact with the second conductive layers 50. The protective member 32 has the same three-dimensional shape as the laminate structure 12. The configuration of the protective member 32 is not particularly limited as long as the protective member can protect the transparent conductive member 30, and in particular, any conductive layer. For example, glass, polycarbonate (PC), polyethylene terephthalate (PET), or the like can be used.

The protective member 32 may serve as a touch surface of the touch panel. In this case, the cover member 24 is not required. At least one of a hard coat layer or an antireflection layer may be provided on the front surface of the protective member 32.

The laminate 20 shown in FIGS. 3A and 3B has a configuration of the protective member 32/the second conductive layer 50/the transparent substrate 36/the first conductive layer 40. For example, the protective member 32 of the laminate 20 becomes the planar portion 12a and the bent portions 12b and 12c of the laminate structure 12.

The transparent substrate 36 has flexibility and electric insulation. The transparent substrate 36 supports the first conductive layers 40 and the second conductive layers 50. As the transparent substrate 36, for example, a plastic film, a plastic plate, a glass plate, or the like can be used. The plastic film and the plastic plate can be made of, for example, polyesters, such as polyethylene terephthalate (PET) or polyethylene naphthalate (PEN), polyolefins, such as polyethylene (PE), polypropylene (PP), polystyrene, ethylene vinyl acetate (EVA), cycloolefin polymer (COP), or cycloolefin copolymer (COC), vinyl-based resin, polycarbonate (PC), polyamide, polyimide, acrylic resin, triacetylcellulose (TAC), or the like. From the viewpoint of light transmittance, heat shrinkability, processability, and the like, it is preferable that the plastic film and the plastic plate are made of polyethylene terephthalate (PET).

The fine metal wires 38 constituting the first conductive layers 40 and the second conductive layers 50 are not particularly limited, and are formed of, for example, ITO, Au, Ag, or Cu. The fine metal wires 38 may be made of ITO, Au, Ag, or Cu and binder. The fine metal wires 38 contain the binder, whereby bending processing gets easier and bending resistance is improved. For this reason, it is preferable that the first conductive layers 40 and the second conductive layers 50 are made of a conductor containing a binder. As the binder, a binder which is used for a wiring of a conductive film can be suitably used, and for example, a binder described in JP2013-149236A can be used.

If the first conductive layers 40 and the second conductive layers 50 are formed of mesh electrodes having a mesh shape in which the fine metal wires 38 intersect each other, it is possible to reduce resistance, to suppress disconnection during molding in a three-dimensional shape, and to reduce the influence of the resistance value even if disconnection occurs.

The wire width of the fine metal wires 38 is not particularly limited, and preferably, is equal to or less than 30 μm, more preferably, equal to or less than 15 μm, still more preferably, equal to or less than 10 μm, particularly preferably, equal to or less than 7 μm, and most preferably, equal to or less than 4 μm, and preferably, is equal to or greater than 0.5 μm, and more preferably, equal to or greater than 1.0 μm. If the wire width is within the above-described range, the first conductive layers 40 and the second conductive layers 50 can be formed to have low resistance comparatively easily.

In a case where the fine metal wires 38 are applied as a peripheral wiring (lead wiring) in a conductive film for a touch panel), the wire width of the fine metal wires 38 is preferably equal to or less than 500 μm, more preferably, equal to or less than 50 μm, and particularly preferably, equal to or less than 30 μm. If the wire width is within the above-described range, the touch panel electrodes having low resistance can be comparatively easily formed.

In a case where the fine metal wires 38 are applied as a peripheral wiring in a conductive film for a touch panel, the peripheral wiring in the conductive film for a touch panel may be formed of a mesh pattern electrode, and in this case, a preferable wire width is the same as the preferable wire width of the fine metal wires 38 employed in the above-described conductive layers. The peripheral wiring in the conductive film for a touch panel is preferably formed of a mesh pattern electrode in that, in a process for irradiating pulse light from a xenon flash lamp, it is possible to increase uniformity of reduction in resistance by irradiation of the conductive layers, the terminal portions, and the peripheral wiring, to make the peel strength of the conductive layers, the terminal portions, and the peripheral wiring constant in a case of attaching a transparent adhesive layer, and to make an in-plane distribution small.

The thickness of the fine metal wires 38 is not particularly limited, and preferably, is 0.01 μm to 200 μm, more preferably, equal to or less than 30 μm, still more preferably, equal to or less than 20 μm, particularly preferably, 0.01 μm to 9 μm, and most preferably, 0.05 μm to 5 μm. If the thickness is within the above-described range, it is possible to comparatively form the touch panel electrodes having low resistance and excellent durability.

A method of forming the first conductive layers 40 and the second conductive layers 50 is not particularly limited. For example, the conductive layers can be formed by exposing and developing a photosensitive material having an emulsion layer containing photosensitive silver halide salt. Furthermore, the first conductive layers 40 and the second conductive layers 50 can be formed by forming metal foils on the transparent substrate 36 and printing resist on the respective metal foils in a pattern shape, or by patterning resist coated on the entire surface through exposure and development and etching metal in an opening. In addition, as the method of forming the first conductive layers 40 and the second conductive layers 50, a method which prints paste containing fine particles of the material constituting the conductor described above and performs metal plating on the paste, and a method which uses an ink jet method using ink containing fine particles of the material constituting the conductor described above are exemplified.

The terminal portions (not shown), the first wirings 42, the terminal 44, the second wirings 52, and the terminal 54 can be formed, for example, by the method of forming the fine metal wires 38 described above.

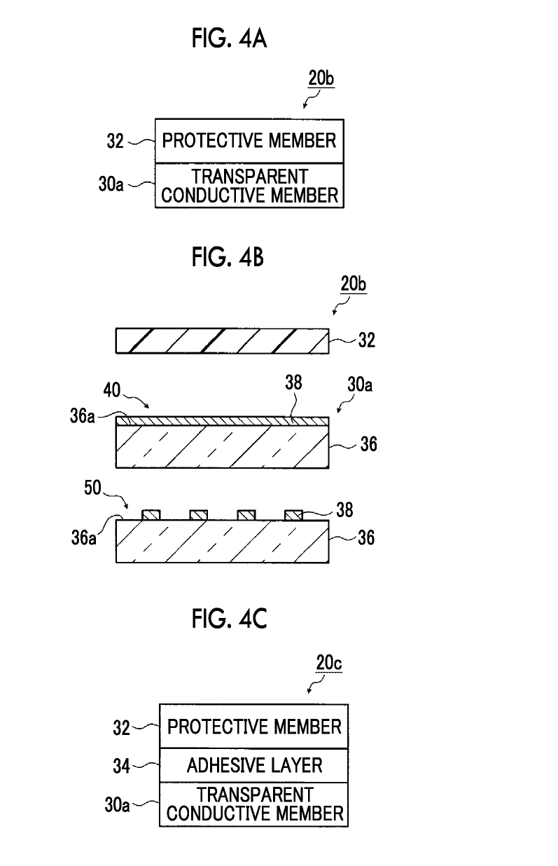

The invention is not limited to the configuration of the laminate 20 shown in FIGS. 3A and 3B, and for example, a laminate 20a shown in FIG. 3C or a laminate 20b shown in FIGS. 4A and 4B may be applied.

FIG. 3C is a schematic view showing a modification example of an example of the laminate of the laminate structure according to the embodiment of the invention, FIG. 4A is a schematic view showing another example of the laminate of the laminate structure according to the embodiment of the invention, and FIG. 4B is a schematic sectional view showing another example of the transparent conductive member.

Although the laminate 20a and the laminate 20b have a three-dimensional shape like the laminate structure 12, like the laminate 20, in FIGS. 3C, and 4A and 4B, in order to show the configurations of the laminates 20a and 20b, the laminates 20a and 20b are shown in a planar shape.

The laminate 20a shown in FIG. 3C is different from the laminate 20 shown in FIG. 3A in that an adhesive layer 34 is provided between the protective member 32 and the transparent conductive member 30, and the protective member 32, the adhesive layer 34, the transparent conductive member 30, and the adhesive layer 34, and the protective member 32 are laminated in this order from below. Other configurations are the same as those of the laminate 20 shown in FIGS. 3A and 3B, and thus, detailed description thereof will not be repeated.

The adhesive layer 34 is to bond the protective member 32 to the transparent conductive member 30, and is constituted of an optically transparent adhesive layer. The adhesive layer 34 is not particularly limited as long as the adhesive layer is optically transparent and can bond the protective member 32 to the transparent conductive member 30. For example, an optically transparent adhesive (OCA) or optically transparent resin (OCR), such as UV curable resin, can be used. The term “optically transparent” is the same as the definition of the term “transparent” described above.

The form of the adhesive layer 34 is not particularly limited, and the adhesive layer 34 may be formed by coating an adhesive or an adhesive sheet may be used.

The laminate 20b shown in FIGS. 4A and 4B is different from the laminate 20 shown in FIGS. 3A and 3B in view of the configuration of a transparent conductive member 30a. Other configurations are the same as those of the laminate 20 shown in FIGS. 3A and 3B, and thus, detailed description thereof will not be repeated.

As shown in FIG. 4B, in a transparent conductive member 30a, the first conductive layers 40 constituted of the fine metal wires 38 are formed on the front surface 36a of the transparent substrate 36, and the second conductive layers 50 constituted of the fine metal wires 38 are formed on a front surface 36a of another transparent substrate 36. The transparent conductive member 30a is formed by arranging an optically transparent adhesive layer (not shown) on the second conductive layers 50 and laminating the two transparent substrates 36. In this way, the conductive layers may be formed on each transparent substrate 36, and the respective transparent substrates 36 may be laminated.

The laminate 20b may have the configuration of a laminate 20c shown in FIG. 4C. FIG. 4C is a schematic view showing another modification example of the laminate of the laminate structure according to the embodiment of the invention.

The laminate 20c has the same configuration as the laminate 20b shown in FIGS. 4A and 4B, excluding that an adhesive layer 34 is provided between the transparent conductive member 30a and the protective member 32, and thus, detailed description thereof will not be repeated. The adhesive layer 34 of the laminate 20c has the same configuration as the adhesive layer 34 of the laminate 20a shown in FIG. 3C, and thus, detailed description thereof will not be repeated.

All of the transparent conductive members 30 of the laminates 20 and 20a and the transparent conductive members 30a of the laminates 20b and 20c may protrude from the protective member 32. If the adhesive layer 34 is provided, the transparent conductive member may protrude from the protective member 32 and the adhesive layer 34. With this, it is possible to facilitate connection of the FPC 15 to the terminal 44 and the terminal 54.

Next, the arrangement of the first conductive layers 40, the first wirings 42, the terminal 44, and the FPC 15 will be described.

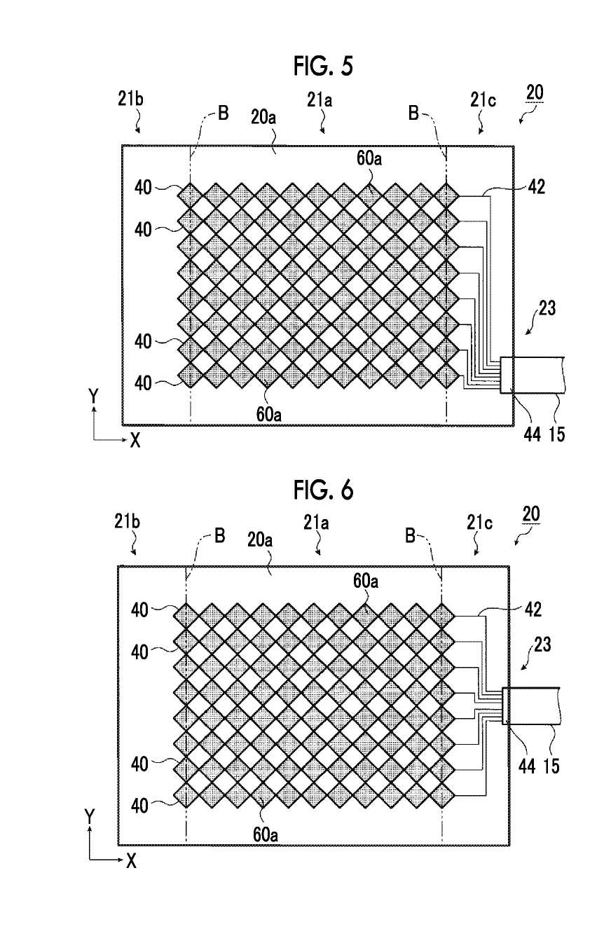

FIG. 5 is a schematic view showing an example of the arrangement of first conductive layers and first wirings in the laminate of the laminate structure according to the embodiment of the invention. As described above, although the laminate 20 has a three-dimensional shape, in FIG. 5, the laminate 20 constituting the laminate structure 12 is shown in a plan view. In the laminate 20 shown in FIG. 5, a region 21a sandwiched between two bending portions B corresponds to the planar portion 12a of the laminate structure 12, and regions 21b and 21c outside the bending portions B correspond to the bent portions 12b and 12c of the laminate structure 12.

As shown in FIG. 5, a plurality of first conductive layers 40 extending in the X direction are provided in parallel in the Y direction. The first conductive layers 40 are also arranged in the regions 21b and 21c outside the bending portions B, and the first conductive layers 40 are arranged in the bent portions 12b and 12c.

The first wirings 42 are electrically connected to the respective first conductive layers 40 through the terminal portions (not shown) in the region 21c corresponding to the bent portion 12c.

The first wirings 42 are respectively routed to a tip 23 of the region 21c and are connected to the terminal 44 provided at the tip 23 of the region 21c. The FPC 15 is connected to the terminal 44. The tip 23 of the region 21c corresponds to the tip 13 of the bent portion 12c.

Since the first conductive layers 40 are arranged across the bending portion B, and the first conductive layers 40 are bent, sensing of the first conductive layers 40 across the bending portion B is difficult, and in order to allow sensing, it is necessary to minimize other kinds of noise. However, the first wirings 42 concentrate on the tip 23 of the region 21c corresponding to the tip 13 of the bent portion 12c, whereby it is possible to shorten the length of the first wiring 42. With this, it is possible to reduce noise and to facilitate sensing of the first conductive layers 40 across the bending portion B. In a case of concentrating the first wirings 42 on the tip 23 of the region 21c corresponding to the tip 13 of the bent portion 12c, it is preferable to concentrate 90% or more of a plurality of first wirings 42.

The first wirings 42 concentrate on the bent portion 12c, and the FPC 15 is provided at the tip 23 of the region 21c, whereby it is possible to shorten the distance to the controller 14 and to shorten the FPC 15. With this, it is possible to suppress the influence of noise. A form of routing the first wirings 42 is not limited to that shown in FIG. 5.

FIG. 6 is a schematic view showing another example of the arrangement of the first conductive layers and the first wirings in the laminate of the laminate structure according to the embodiment of the invention. FIG. 6 shows a laminate 20 in a plan view like FIG. 5. In the laminate 20 shown in FIG. 6, the same components as those of the laminate 20 shown in FIG. 5 are represented by the same reference numerals, and detailed description thereof will not be repeated.

Like the laminate 20 shown in FIG. 6, the terminal 44 may be arranged at the tip 23 of the region 21c corresponding to the tip 13 of the bent portion 12c and at the center in the Y direction. In this case, it is possible to make the total length of the first wirings 42 shorter than the laminate 20 shown in FIG. 5. With this, it is possible to reduce noise and to further facilitate sensing of the first conductive layers 40 across the bending portion B. Even in the laminate 20 of FIG. 6, it is possible to make the FPC 15 as short as the laminate 20 shown in FIG. 5, and to thus reduce the influence of noise.

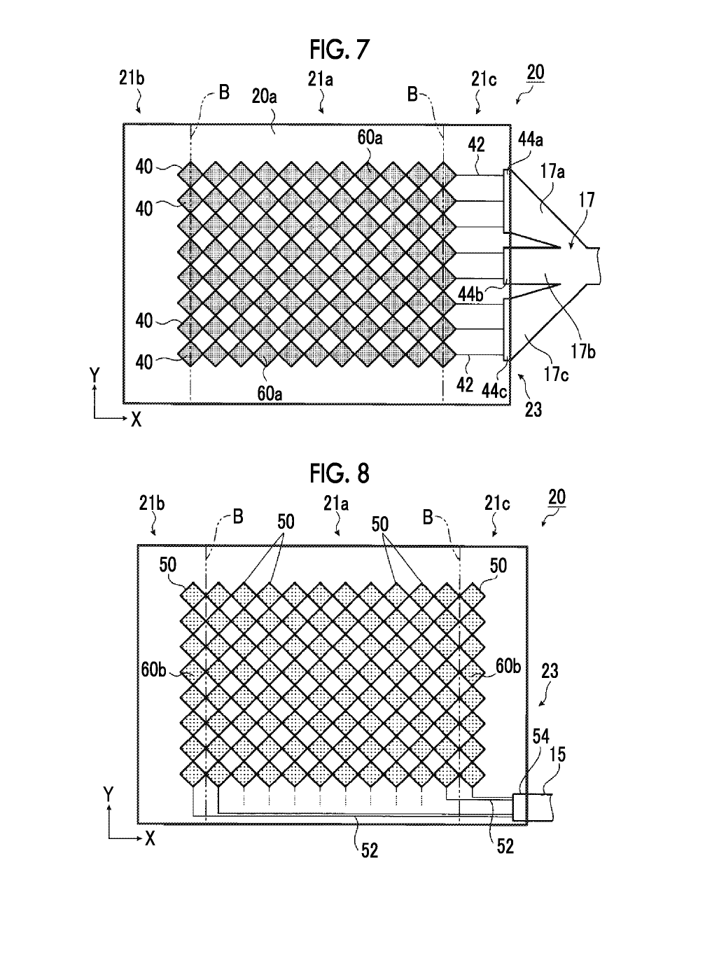

In addition, a form of routing the first wirings 42 may have a configuration shown in FIG. 7.

FIG. 7 is a schematic view showing another example of the arrangement of the first conductive layers and the first wirings in the laminate of the laminate structure according to the embodiment of the invention. FIG. 7 shows a laminate 20 in a plan view like FIG. 5. In the laminate 20 shown in FIG. 7, the same components as those of the laminate 20 shown in FIG. 5 are represented by the same reference numerals, and detailed description thereof will not be repeated.

Like the laminate 20 shown in FIG. 7, three terminals including a first terminal 44a, second terminal 44b, and a third terminal 44c may be arranged at the tip 23 of the region 21c corresponding to the tip 13 of the bent portion 12c and at positions at regular intervals in the Y direction. In this case, the first wirings 42 of three first conductive layers 40 are connected to the first terminal 44a, the first wirings 42 of two first conductive layers 40 are connected to the second terminal 44b, and the first wirings 42 of three first conductive layers 40 are connected to the third terminal 44c. While the number of terminals and the number of connections of the first wirings 42 of the first conductive layers 40 to each terminal are not particularly limited, it is preferable that the number of connections to each terminal is identical, and the first wirings 42 have the same length. With this, it is possible to achieve uniformity of wiring resistance, and for example, to reduce variation in sensing characteristics.

In a case where a plurality of terminals are provided, it is preferable to use an FPC which is a single wiring member and has, for example, branch portions corresponding to the number of a plurality of terminals. With this, even if there are a plurality of terminals, it should suffice that the controller 14 and one FPC 15 are connected, and the connection to the controller 14 is not complicated. For this reason, for example, an FPC 17 having three branch portions 17a, 17b, and 17c is used. In this case, the branch portion 17a of the FPC 17 is connected to the first terminal 44a, the branch portion 17b is connected to the second terminal 44b, and the branch portion 17c is connected to the third terminal 44c.

Even in the form of routing the first wirings 42 shown in FIG. 7, it is possible to make the total length of the first wirings 42 shorter than the laminate 20 shown in FIG. 5, and with this, it is possible to reduce noise, and to further facilitate sensing of the first conductive layers 40 across the bending portion B. Even in the laminate 20 of FIG. 7, it is possible to make the FPC 17 as short as the laminate 20 shown in FIG. 5, and thus, it is possible to reduce the influence of noise.

The FPC 15 may be connected to the first terminal 44a, the second terminal 44b, and the third terminal 44c.

Next, the arrangement of the second conductive layers 50, the second wirings 52, the terminal 54, and the FPC 15 will be described.

FIG. 8 is a schematic view showing an example of the arrangement of second conductive layers and second wirings in the laminate of the laminate structure according to the embodiment of the invention. FIG. 8 shows a laminate 20 in a plan view like FIG. 5. In the laminate 20 shown in FIG. 8, the same components as those of the laminate 20 shown in FIG. 5 are represented by the same reference numerals, and detailed description thereof will not be repeated.

As shown in FIG. 8, a plurality of second conductive layers 50 extending in the Y direction are provided in parallel in the X direction. The second conductive layers 50 are arranged in the regions 21b and 21c outside the bending portions B, and the second conductive layers 50 are arranged in the bent portions 12b and 12c. With this, sensing in the bent portions 12b and 12c becomes possible.

The second wirings 52 are electrically connected to the respective second conductive layers 50 through the terminal portions (not shown). The respective second wirings 52 are routed and connected to the terminal 54 provided at the tip 23 of the region 21c corresponding to the tip 13 of the bent portion 12c. The FPC 15 is connected to the terminal 54.

The second wirings 52 concentrates on the bent portion 12c and the FPC 15 is provided at the tip 23 of the region 21c, whereby it is possible to shorten the length of the FPC 15. With this, it is possible to suppress the influence of noise. While the second wirings 52 may be routed to both of the region 21b and the region 21c, in this case, the number of FPCs increases, and the total length of the FPCs becomes longer than when one FPC is provided. Since the FPC is susceptible to noise, it is preferable that the length of the FPC is short. If the number of connections of the controller 14 and the FPC increases, the configuration of the controller 14 becomes complicated. In addition, since it is necessary to take the influence of noise at the connection places of the controller 14 and the FPC 17 into consideration, the number of FPCs provided for each of the first conductive layers 40 and the second conductive layers 50 is one, and the length of the FPC needs to be shortened.

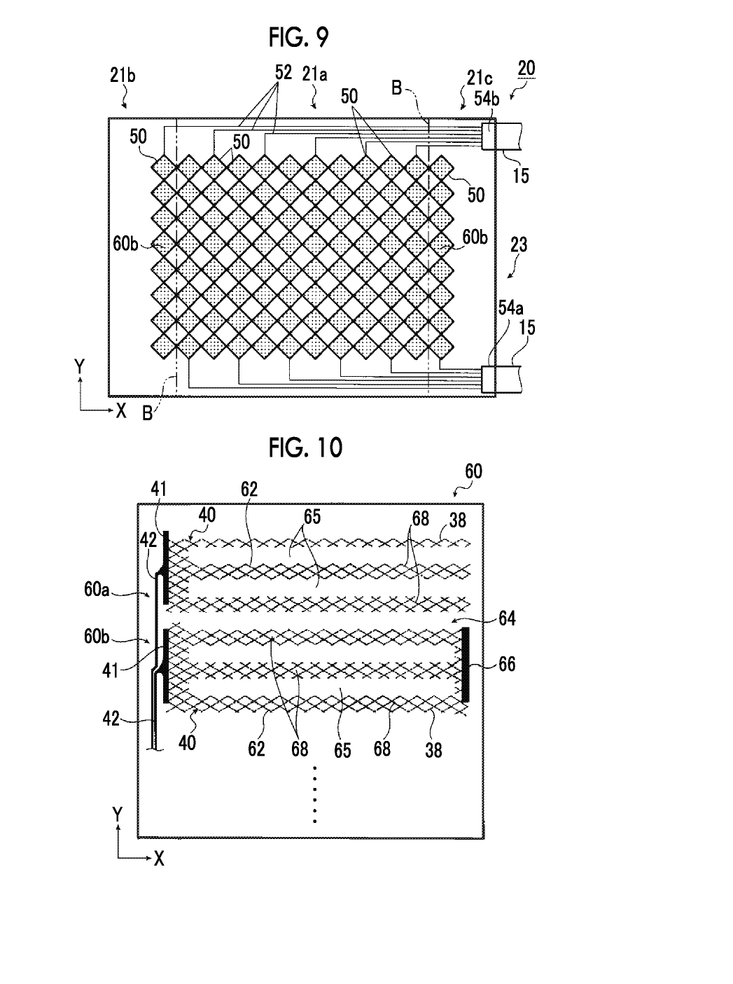

The form of routing the second wiring 52 may have a configuration shown in FIG. 9.

FIG. 9 is a schematic view showing another example of the arrangement of the second conductive layers and the second wirings in the laminate of the laminate structure according to the embodiment of the invention. FIG. 9 shows a laminate 20 in a plan view like FIG. 5. In the laminate 20 shown in FIG. 9, the same components as those of the laminate 20 shown in FIG. 8 are represented by the same reference numerals, and detailed description thereof will not be repeated.

Like the laminate 20 shown in FIG. 9, two terminals including a first terminal 54a and a second terminal 54b may be arranged at both ends in the Y direction of the tip 23 of the region 21c corresponding to the tip 13 of the bent portion 12c. In this case, the second wirings 52 of six second conductive layers 50 are connected to the first terminal 54a, and the second wirings 52 of six second conductive layers 50 are connected to the second terminal 54b. While the number of terminals and the number of connections of the second wirings 52 of the second conductive layers 50 are not particularly limited, it is preferable that the number of connections to each terminal is identical, and the first wirings 42 have the same length. With this, it is possible to achieve uniformity of wiring resistance, and for example, to reduce variation in sensing characteristics.

The FPCs 15 are respectively connected to the first terminal 54a and the second terminal 54b. As described above, in order to shorten the total length of the FPCs and to suppress an increase in the number of connection places to the controller 14, it is preferable that connection is made to the first terminal 54a and the second terminal 54b using an FPC which is a single wiring member and has, for example, branch portions corresponding to the number of terminals. For example, it is preferable that connection is made using an FPC having two branch portions.

Even in the laminate 20 shown in FIG. 9, the second wirings 52 concentrate on the bent portion 12c and the FPC 15 is provided at the tip 23 of the region 21c, whereby it is possible to shorten the length of the FPC 15. With this, it is possible to suppress the influence of noise.

Since the first conductive layers 40 and the second conductive layers 50 are formed in different layers even in the configuration of any of the laminate 20, the laminate 20a, the laminate 20b, and the laminate 20c, the FPCs 15 are not connected to the same layer, and a combination of the first conductive layers 40 and the second conductive layers 50 is not particularly limited. Any combination of FIGS. 5 and 8, FIGS. 5 and 9, FIGS. 6 and 8, FIGS. 6 and 9, FIGS. 7 and 8, and FIGS. 7 and 9 may be made. In the combination of FIGS. 5 and 8, the FPCs 15 can be connected at the same position at the tip 13 of the bent portion 12c. In the combination of FIGS. 6 and 9, the three terminals are arranged at the tip 13 of the bent portion 12c, and for example, connection can be made using the FPC 17 shown in FIG. 7. As will be understood from the drawings, it is preferable to concentrate 90% or more of a plurality of wirings (first wirings 42 and second wirings 52) led out from a plurality of conductive layers on the bent portion 12c, and it is most preferable to concentrate all of a plurality of wirings (first wirings 42 and second wirings 52) on the bent portion 12c.

The first conductive layers 40 and the second conductive layers 50 are not necessarily provided in the bent portion 12b, on which the wirings do not concentrate, out of the two bent portions 12b and 12c.

In order to make the total length of the first wirings 42 of the first conductive layers 40 across the bent portion 12c shorter than the total length of the second wirings 52 of the second conductive layers 50, it is preferable concentrate the terminal 44 on the bent portion 12c to which the first wirings 42 connected to the first conductive layers 40 across the bent portion 12c are routed.

The total length of the first wiring 42 is made shorter than the total length of the second wirings 52, whereby it is possible to reduce noise to the first wirings 42 and to further facilitate sensing of the first conductive layers 40 across the bending portion B.

In the forms shown in FIGS. 5 to 9, although description has been described using the laminate 20, the configuration of the laminate is not limited thereto, and any of the laminates 20a, 20b, and 20c may be applied. The transparent conductive members 30 and 30a may protrude from the protective member 32, and in a case where the adhesive layer 34 is provided, may protrude from the protective member 32 and the adhesive layer 34.

The form of the touch panel is not limited to the touch panel 10 shown in FIG. 1, and a configuration may be made in which either of the first conductive layers 40 or the second conductive layers 50 are provided. In this case, the position in a direction of either of the X direction or the Y direction is detected.

Next, a first conductive pattern 60 of the first conductive layers 40 will be described.

FIG. 10 is a schematic view showing an example of a first conductive pattern of the first conductive layers in the laminate of the laminate structure according to the embodiment of the invention.

As shown in FIG. 10, the first conductive layers 40 have a first conductive pattern 60 constituted of a plurality of lattices 62 extending in the X direction by the fine metal wires 38. A plurality of lattices 62 have a substantially uniform shape. The term “substantially uniform” means that the lattices 62 have the same shape and size at a glance, in addition to a case where the lattices completely coincide with one another. The first conductive pattern 60 has two patterns including a first first conductive pattern 60a and a second first conductive pattern 60b.

Each first conductive layer 40 is electrically connected to a first electrode terminal 41 at one end thereof. Each first electrode terminal 41 is electrically connected to one end of each first wiring 42. Each first wiring 42 is electrically connected to the terminal 44 (see FIG. 1) at the other end thereof. The first first conductive pattern 60a and the second first conductive pattern 60b are electrically separated from each other by a first non-conductive pattern 64.

In a case of being used as a transparent conductive film arranged before a display requiring visibility, as the first non-conductive pattern 64, a dummy pattern constituted of the fine metal wires 38 having a disconnection portion described below is formed. In a case of being used as a transparent conductive film arranged before a notebook personal computer, a touch pad, or the like particularly not requiring visibility, as the first non-conductive pattern 64, a dummy pattern constituted of the fine metal wires is not formed and a space is left.

The first first conductive pattern 60a and the second first conductive pattern 60b comprise slit-like non-conduction patterns 65 for electric separation, and comprise a plurality of first conductive pattern columns 68 divided by the respective non-conduction patterns 65.

In a case of being used as a transparent conductive film arranged before a display requiring visibility, as the non-conduction patterns 65, a dummy pattern constituted of the fine metal wires 38 having a disconnection portion described below is formed. In a case of being used as a transparent conductive film arranged before a notebook personal computer, a touch pad, or the like particularly not requiring visibility, as the non-conduction patterns 65, a dummy pattern constituted of the fine metal wires 38 is not formed and a space is left.

The first first conductive pattern 60a comprises the slit-like non-conduction patterns 65 whose the other end is opened as shown on the upper side of FIG. 10. Since the other end is opened, the first first conductive pattern 60a becomes a comb-like structure. The first first conductive pattern 60a has three first conductive pattern columns 68 formed by the two non-conductions patterns 65. The first conductive pattern columns 68 are respectively connected to the first electrode terminal 41, and thus, become the same potential.

The second first conductive pattern 60b comprises an additional first electrode terminal 66 at the other end as shown on the lower side of FIG. 10. The slit-like non-conduction patterns 65 are closed in the first conductive pattern 60. The additional first electrode terminal 66 is provided, whereby it is possible to easily perform the inspection of the first conductive pattern 60. The second first conductive pattern 60b has three first conductive pattern columns 68 formed by the two closed non-conduction patterns 65. The first conductive pattern columns 68 are respectively connected to the first electrode terminal 41 and the additional first electrode terminal 66, and thus, become the same potential. The first conductive pattern columns are one modification example of the comb-like structure.

The number of first conductive pattern columns 68 may be equal to or greater than two, equal to or less than ten, and preferably, is determined in consideration of the relationship with pattern design of the fine metal wires 38 within a range of equal to or less than seven.

The pattern shapes of the fine metal wires of the three first conductive pattern columns 68 may be identical or different. In FIG. 10, the respective first conductive pattern columns 68 have different shapes. In the first first conductive pattern 60a, the uppermost first conductive pattern column 68 out of the three first conductive pattern columns 68 is constituted by extending adjacent inverted V-shaped fine metal wires 38 while intersecting each other. The upper first conductive pattern column 68 becomes a structure in which the lattices 62 do not have a complete shape with no lower vertical angle. The central first conductive pattern column 68 is constituted in two columns by extending the lattices 62 in the X direction while bringing the sides of adjacent lattices 62 into contact with each other. The lowermost first conductive pattern column 68 is constituted by extending the lattices 62 while bringing the vertical angles of adjacent lattices 62 into contact with each other, and extending one side of each lattice 62.

In the second first conductive pattern 60b, the uppermost first conductive pattern column 68 and the lowermost first conductive pattern column 68 have the substantially same lattice shape, and are constituted in two columns by extending the lattices 62 in the X direction while bringing the sides of adjacent lattices 62 into contact with each other. The central first conductive pattern column 68 of the second first conductive pattern 60b is constituted by extending the lattices 62 in the X direction while bringing the vertical angles of adjacent lattices 62 into contact with each other, and extending one side of each lattice 62.

Next, a second conductive pattern 70 of the second conductive layer 50 will be described.

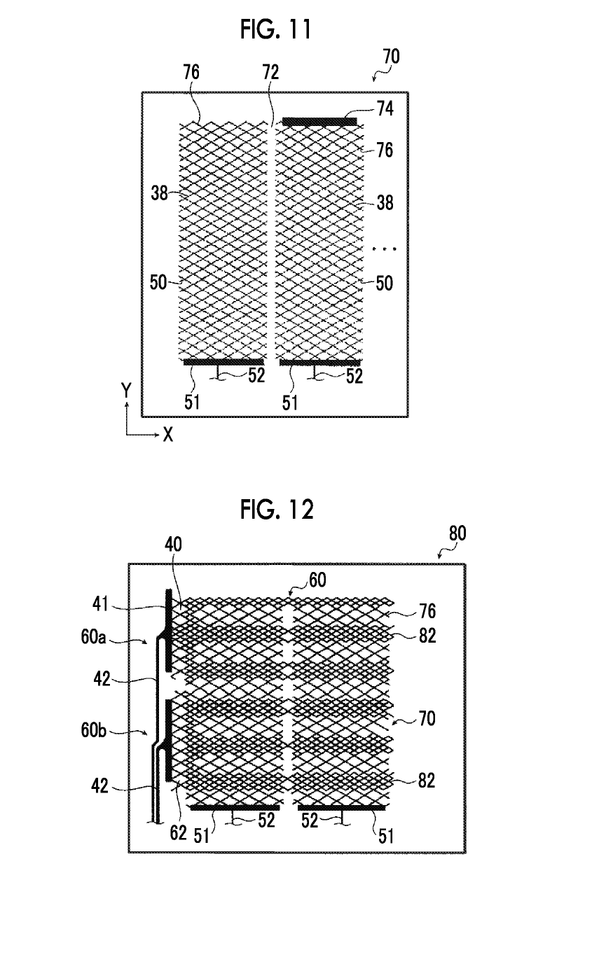

FIG. 11 is a schematic view showing an example of a second conductive pattern of the second conductive layers in the laminate of the laminate structure according to the embodiment of the invention.

As shown in FIG. 11, the second conductive pattern 70 is constituted of multiple lattices by the fine metal wires 38. The second conductive pattern 70 has a plurality of second conductive layers 50 which extend in the Y direction and are arranged in parallel in the X direction. The respective second conductive layers 50 are electrically separated from each other by a second non-conductive pattern 72.

In a case of being used as a transparent conductive film arranged before a display requiring visibility, as the second non-conductive pattern 72, a dummy pattern constituted of the fine metal wires 38 having a disconnection portion is formed. In a case of being used as a transparent conductive film arranged before a notebook personal computer, a touch pad, or the like particularly not requiring visibility, as the second non-conductive pattern 72, a dummy pattern constituted of the fine metal wires 38 is not formed and a space is left.

The respective second conductive layers 50 are electrically connected to terminals 51. Respective terminals 51 are electrically connected to the conductive second wirings 52. The respective second conductive layers 50 are electrically connected to the terminals 51 at one end thereof. The respective terminals 51 are electrically connected to one end of the respective second wirings 52. The respective second wirings 52 are electrically connected to the terminal 54 (see FIG. 1) at the other end thereof. In the second conductive pattern 70, the second conductive layers 50 have a striped structure having a substantially constant width in the Y direction, but are not limited to the striped shape.

The second conductive pattern 70 may be provided with an additional second electrode terminal 74. The additional second electrode terminal 74 is provided, whereby it is possible to easily perform the inspection of the second conductive pattern 70.

In FIG. 11, the second conductive layer 50 with no additional second electrode terminal 74 and the second conductive layer 50 with the additional second electrode terminal 74 are formed on the same surface. However, the second conductive layer 50 with the additional second electrode terminal 74 and the second conductive layer 50 with no additional second electrode terminal 74 do not need to be mixed, and only one second conductive layer 50 may be formed.

The second conductive pattern 70 includes a plurality of lattices 76 constituted of the fine metal wires 38 intersecting each other, and the lattices 76 have the substantially same shape as the lattices 62 of the first conductive pattern 60. The length of one side of the lattices 76 and the aperture ratio of the lattices 76 are the same as the lattices 62 of the first conductive pattern 60.

FIG. 12 shows a combination pattern obtained by arranging the first conductive pattern 60 having a comb-like structure and the second conductive pattern 70 having a striped structure to face each other. The first conductive pattern 60 and the second conductive pattern 70 are orthogonal to each other, and a combination pattern 80 is formed by the first conductive pattern 60 and the second conductive pattern 70.

The combination pattern 80 shown in FIG. 12 is a combination of the first conductive pattern 60 with no dummy pattern and the second conductive pattern 70 with no dummy pattern.

In the combination pattern 80, in a top view, small lattices 82 are formed by the lattices 62 and the lattices 76. That is, intersections of the lattices 62 are arranged substantially at the center of the opening regions of the lattices 76. The small lattices 82 have one side having a length corresponding to half the length of one side of the lattices 62 and the lattices 76. The length of one side is, for example, equal to or greater than 125 μm and equal to or less than 450 μm, and preferably, equal to or greater than 150 μm and equal to or less than 350 μm.

Next, a method of molding the laminate structure 12 of this embodiment will be described.

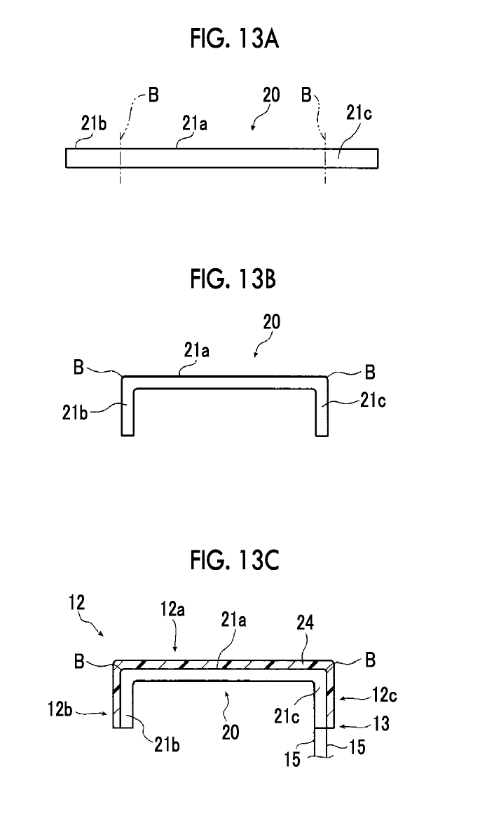

FIGS. 13A to 13C are schematic views showing a method of molding the laminate structure according to the embodiment of the invention.

As shown in FIG. 13A, first, a flat plate-shaped laminate 20 is prepared. The laminate 20 is divided into a region 21a corresponding to a planar portion and regions 21b and 21c corresponding to bent portions by the bending portions B.

The laminate 20 is made in a stereoscopic shape by bending both ends thereof in the bending portions B as shown in FIG. 13B. When bending the flat plate-shaped laminate 20, the laminate 20 is heated to a temperature determined in advance, and then, is cooled to room temperature.

Next, as shown in FIG. 13C, the molded laminate 20 is attached inside the cover member 24, for example, an optically transparent adhesive. With this, the laminate structure 12 shown in FIG. 2 can be obtained.

In a case where resin is used for the cover member 24, the laminate structure 12 can be obtained using an insert molding method.

In a case of being attached to the cover member 24 using an optically transparent adhesive, it is preferable that the FPC 15 is provided in the laminate 20. In a case of using an insert molding method, the FPC 15 can be provided in the laminate 20 after insert molding.

The invention is basically configured as described above. Although the laminate structure and the touch panel module of the invention have been described above in detail, the invention is not limited to the foregoing embodiment, and various improvements or modifications may be made without departing from the scope of the invention.

### EXPLANATION OF REFERENCES

10: touch panel
12: laminate structure
12a: planar portion
12b, 12c: bent portion
14: controller
15: flexible circuit board (FPC)
16: touch panel module
18: display device
20, 20a, 20b, 20c: laminate
22, 34: adhesive layer
24: cover member
30, 30a: transparent conductive member
32: protective member
36: transparent substrate
38: fine metal wire
40: first conductive layer
42: first wiring
44, 54: terminal
50: second conductive layer
52: second wiring
60: first conductive pattern
70: second conductive pattern

What is claimed is:

1. A laminate structure comprising:
a laminate which has a three-dimensional shape and is provided with
a protective member,
at least one conductive layer formed on the protective member, and
a wiring electrically connected to the conductive layer,
wherein the laminate has at least a planar portion and a bent portion formed continuously to the planar portion, and
the wiring is routed to the bent portion and is connected to a flexible wiring member at the tip of the bent portion.

2. A laminate structure comprising:
a laminate which has a three-dimensional shape and is provided with
a transparent conductive member having a plurality of conductive layers constituted of fine metal wires on a flexible transparent substrate,
a wiring formed on the transparent substrate and electrically connected to each conductive layer,
a protective member having an optically transparent region and protecting the transparent conductive member, and
an optically transparent adhesive layer positioned between the transparent conductive member and the protective member,
wherein the laminate has at least a planar portion and a bent portion formed continuously to the planar portion, and
the wiring is routed to the bent portion and is connected to a flexible wiring member at the tip of the bent portion.

3. The laminate structure according to claim 2,
wherein the total length of the wiring electrically connected to a conductive layer arranged across the bent portion among the plurality of conductive layers is shorter than the total length of the wiring electrically connected to other conductive layers.

4. The laminate structure according to claim 1,
wherein the wiring member is connected to an external apparatus.

5. The laminate structure according to claim 2,
wherein the wiring member is connected to an external apparatus.

6. The laminate structure according to claim 2,
wherein the transparent conductive member is arranged inside the bent portion of the protective member.

7. The laminate structure according to claim 1,
wherein the conductive layers have a conductive pattern having a mesh structure constituted of the fine metal wires.

8. The laminate structure according to claim 2,
wherein the conductive layers have a conductive pattern having a mesh structure constituted of the fine metal wires.

9. The laminate structure according to claim 2,
wherein the conductive layers are formed on both surfaces of the transparent substrate.

10. The laminate structure according to claim 2,
wherein the conductive layers are formed on one surface of the transparent substrate, and two transparent substrates on which the conductive layers are formed on one surface are laminated.

11. The laminate structure according to claim 1,
wherein the wiring routed to the bent portion is connected to a terminal provided at the tip of the bent portion, and the wiring member is connected to the terminal.

12. The laminate structure according to claim 2,
wherein the wiring routed to the bent portion is connected to a terminal provided at the tip of the bent portion, and the wiring member is connected to the terminal.

13. The laminate structure according to claim 1,
wherein the wiring routed to the bent portion is connected separately to a plurality of terminals provided at the tip of the bent portion, and the wiring member is connected to the plurality of terminals.

14. The laminate structure according to claim 2,
wherein the wiring routed to the bent portion is connected separately to a plurality of terminals provided at the tip of the bent portion, and the wiring member is connected to the plurality of terminals.

15. The laminate structure according to claim 10,
wherein the wiring member connected to the plurality of terminals is one wiring member having branch portions corresponding to the number of the plurality of terminals.

16. The laminate structure according to claim 2,
wherein the transparent conductive member protrudes from the protective member.

17. A touch panel module comprising:
a laminate structure including
a laminate which has a three-dimensional shape and is provided with
a protective member,
at least one conductive layer formed on the protective member, and
a wiring electrically connected to the conductive layer,
wherein the laminate has at least a planar portion and a bent portion formed continuously to the planar portion, and
the wiring is routed to the bent portion and is connected to a flexible wiring member at the tip of the bent portion.
